(19) United States
(12) Patent Application Publication
(10) Pub. No.: US 2016/0253760 A1
(43) Pub. Date: Sep. 1, 2016

(54) A computer-implemented method for a social media mechanism to rate the liquidity of closed ended private investments

(71) Applicant: Peter MCGRATH, Toronto (CA)

(72) Inventor: Peter McGrath, Toronto (CA)

(21) Appl. No.: 14/767,030

(22) PCT Filed: May 8, 2014
(86) PCT No.: PCT/IB2014/001225

§ 371 Date: Aug. 11, 2015

(51) Int. Cl. G06Q 40/06; G06Q 50/18

(52) U.S. Cl. CPC G06Q 40/06; G06Q 50/18

(57) ABSTRACT

Closed ended private investment Funds may require liquidity rating as those Funds are not readily traded on any exchange or alternative trading system, but traded on limited access market. A new social media mechanism allows assigning liquidity rating to closed ended private investment funds based on potential institutional buyers interest, potential institutional buyers' capacity and Funds' restrictions.

### FIELD OF THE INVENTION

The present invention is related to computer software and mare specifically to computer software for financial analysis of closed ended private fund investments.

### BACKGROUND OF THE INVENTION

“Fund”, as used herein and throughout this description, refers to closed ended private fund investments. Examples of a Fund include but are not limited to private equity, private closed ended Funds of Funds, buy-out, venture capital, real estate, natural resources, and energy Funds that are not openly marketed to the general public and are generally subject to substantial restrictions on transferability. A Fund, in its singular form, refers to a single Fund, or a group of related Funds that have the same strategy and are managed by the same manager.

1. Technical Field

This disclosure generally relates to a financial field combined with social networking, and more specifically relates to rating Funds through communication of information between potential buyers on a social network website.

2. Background Art

Social media has become an important mean of communication in our modern world. Already a large amount of people have accounts with various social media applications including Facebook, Twitter, and LinkedIn allowing them to post messages and communicate to a large number of people. The social media now allows the user to create groups and communicate with other users on specific interests and express interest in specific products.

### BRIEF SUMMARY OF THE INVENTION

This social media mechanism described in this method allows potential buyers and managers of Funds to communicate and exchange information regarding specific Funds. The method allows scoring the liquidity of each specific closed ended private Fund through analysis of the information gathered through the social media mechanism and information obtained through conventional means including, but not limited to, disclosure by the Fund manager, institutional buyers, and agents and information available in the public domain.

“Fund”, as used herein and throughout this description, refers to closed ended private fund investments. Examples of a Fund include but are not limited to private equity, private closed ended Funds of Funds, buy-out, venture capital, real estate, natural resources, and energy Funds that are not openly marketed to the general public and are generally subject to substantial restrictions on transferability. A Fund, in its singular form, refers to a single Fund, or a group of related Funds that have the same strategy and are managed by the same manager.

### BRIEF DESCRIPTION OF THE DRAWINGS

FIG. 1 shows a simplified view of the initial set up required for the method

FIG. 2 shows a simplified view of the system

FIG. 3 shows a flowchart of the method

### DETAILED DESCRIPTION OF THE INVENTION

“Fund”, as used herein and throughout this description, refers to closed ended private fund investments. Examples of a Fund include but are not limited to private equity, private closed ended Funds of Funds, buy-out, venture capital, real estate, natural resources, and energy Funds that are not openly marketed to the general public and are generally subject to substantial restrictions on transferability. A Fund, in its singular form, refers to a single Fund, or a group of related Funds that have the same strategy and are managed by the same manager.

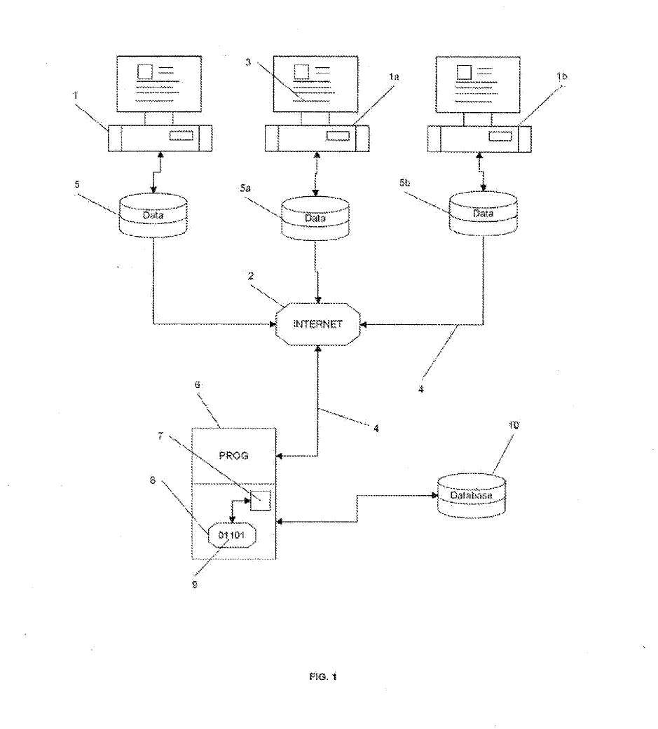

The claims and disclosure herein provide a new method that utilizes a social media mechanism and online communication over the internet to collect data and information from users over the internet, analyses it with other available data and information, and generates liquidity ratings for Funds. The preferred initial hardware embodiment required and its functionality is shown in FIG. 1. The system comprises a computer-readable medium (8) in a server (6), connected (4) to the internet (2), which in turn is connected either with wires or remotely to a plurality of remote terminals (1) of financial data providers who have uploaded financial information (3). A specially designed program (9), comprising computer readable statements and instructions, is stored in the computer readable medium (8), written in a language such as Java, Python, ASP, Sal or any other computer programming language and is capable, when run by a processor (7), of sorting and intelligently filtering data (including semantics methods) (5) provided by users via social media mechanism, Fund managers, institutional investors, financial data providers, and financial intermediaries and reorganizing into a new database (10) that can be stored in the computer readable medium. The database (10) can be updated from time to time by accessing updated data (5) using internet (2) and internet connection (4).

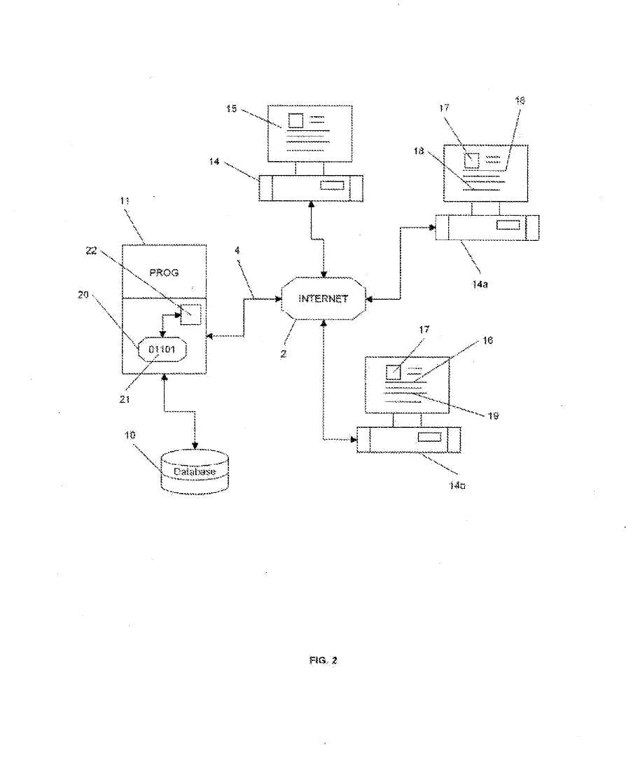

The functionality of the method within hardware embodiment and hardware itself are shown in FIG. 2. The system comprises a computer-readable medium (20) in a server (11), connected (4) to the internet (2), which in turn is connected either with wires or remotely to a plurality of remote terminals (14). A specially designed software application containing the social media mechanism (21), comprising computer readable statements and instructions, is stored in the computer readable medium (20), written in a language such as Java, Python, ASP, Sal or any other computer programming language and is capable, when run by a processor (22), of processing information (15) provided by remote terminals (14) over the internet (2) and of processing information from the database (10) that has been created in the initial stage. The program is configured to display information on a remote terminal (14) including information from the database such as current Fund information (17), Funds liquidity rating and ranking (19), and input parameters used to select the particular Fund (16). The system is designed to receive information from multiple users and terminals (14, 14a, and 14b).

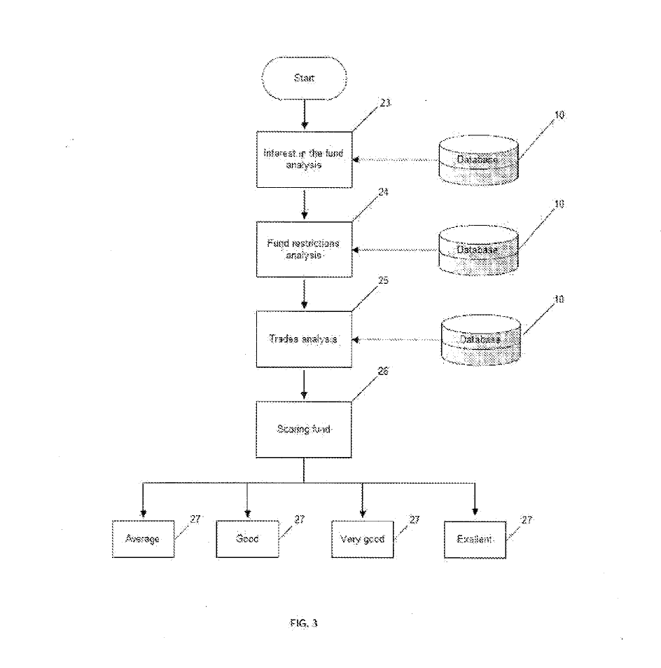

The functionality of the preferred embodiment of the system is shown in FIG. 3. First, the database should be created by the specially designed program in the server as described in FIG. 1. Next, the user of the system would connect to the server that can process information from database as described in FIG. 2. The users would provide Fund information, express their interest in specific Funds, and the users purchasing abilities using forms or wizards, including forms and wizards on social media mechanism, that will, in turn, be collected by the server and processed by the software application. The Fund data and users' interest in the Fund along with legal and financial capability of the users to invest into the Fund would be analyzed (23) by the software application and then the software application would assign and set the initial liquidity score for each Fund. The software application then would analyze each Fund (24), using information from the database (10), as to the restrictions in place for each specific Fund and comparing it against the ability of the interested users to invest in such Fund. The software application then would adjust and assign an adjusted liquidity score for each Fund. The software application then would analyze the potential size of trades for each specific Fund, and also analyse and compare the ability of users to conduct trades based on the potential size of transactions (25). The software application then would adjust and assign a new adjusted liquidity score for each Fund. The application software would analyse (26) the adjusted liquidity score for each Fund and assign a specific liquidity rating (27) based on the final liquidity score, ending the process.

The process may be extended further by allowing the software application to save the liquidity ratings and scores to the database (10). The method may allow the software application to rank Funds based on their liquidity ratings and create a Fund ranking. The method may further allow the software application to generate reports to the user, including liquidity rating reports for multiple Funds and rate the liquidity of a portfolio of Funds.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. A computer-implemented method executed by at least one processor for a social media mechanism to rate the liquidity of a closed ended private investment fund, the method comprises the following: allowing institutional investors to express interest in specific closed ended private investment funds and computing a liquidity score based on investor interest; adjusting the liquidity score by analysing the restrictions placed by the closed ended private investment fund and their management; adjusting the liquidity score by capabilities of the institutional investors to invest into the specific closed ended private investment fund, assigning a liquidity rating based on the final liquidity score of the closed ended private investment fund.

2. The method of claim 1 wherein the step of allowing the institutional investors to express interest in specific closed ended private investment funds and computing a liquidity score based on investor interest comprises the steps of: allowing potential institutional investors to express interest in closed ended private investment funds online, processing information about the potential institutional investors, analysing legal ability of the potential institutional investors to invest into each specific closed ended private investment fund, analysing financial ability of the potential institutional investors to invest in each specific closed ended private investment fund, and assigning a liquidity score.

3. The method of claim 1 wherein the step of adjusting a liquidity score by analysing the restrictions placed by the closed ended private investment funds and their management comprises the steps of: processing information about each specific closed ended private investment fund, analysing legal and financial restrictions in place for each specific closed ended private investment fund, analysing and comparing legal and financial restrictions in place for each specific closed ended private investment fund against the ability of the potential institutional investors, and adjusting the liquidity score.

4. The method of claim 1 wherein the step of adjusting the liquidity score by capabilities of the institutional investors to invest into specific closed ended private investment funds comprises the steps of: analysing potential size of trades in each specific closed ended private investment fund, analysing and comparing the ability of the potential institutional investors to make a purchase of the specific closed ended private investment fund based on the size of potential trades, and adjusting the liquidity score.

5. The method of claim 1 further comprising the step of giving Funds a liquidity rating based on their final liquidity scores.

6. The method of claim 1 further comprising the step of producing reports on Funds based on the liquidity rating.

7. A computer-implemented method to rate the liquidity of closed ended private investment funds, the method comprises the steps of: allowing potential institutional investors to express interest in specific closed ended private investment funds online, including email communication and communication through social media mechanism, processing information about potential institutional investors, analysing the legal ability of the potential institutional investors to invest into each specific closed ended private investment fund, analysing financial ability of the potential institutional investors to invest into each specific closed ended private investment fund, processing information about each specific closed ended private investment fund, analysing legal and financial restrictions in place for each specific closed ended private investment fund, analysing and comparing legal and financial restrictions in place for each closed ended private investment fund that may inhibit purchases by the potential institutional investors, establishing a liquidity score for each specific closed ended private investment fund based on the number of institutional investors that expressed interest in that specific closed ended private investment fund, reducing the liquidity score based on restrictions in place for each specific closed ended private investment fund, and reducing or increasing the liquidity score based on the ability of the potential institutional investors to purchase the specific closed ended private investment funds based on the size of potential trades, and assigning a liquidity rating based on the final liquidity score of each closed ended private investment fund.

8. The method of claim 7 further comprising the step of giving closed ended private investment funds a liquidity rating based on their liquidity scores.

9. The method of claim 1 further comprising the step of producing reports on closed ended private investment funds based on the liquidity rating.
